(19) United States
(12) Patent Application Publication
(10) Pub. No.: US 2024/0076119 A1
(43) Pub. Date: Mar. 7, 2024

(54) TUBULAR CONTAINER AND BEVERAGE BREWING DEVICE THEREOF

(71) Applicant: HONG-FAN WEI, TAIPEI CITY (TW)

(72) Inventor: HONG-FAN WEI, TAIPEI CITY (TW)

(21) Appl. No.: 17/901,916

(22) Filed: Sep. 2, 2022

(51) Int. Cl. B65D 85/804; A47J 31/40; B65D 21/02

(52) U.S. Cl. CPC B65D 85/8064; A47J 31/407; B65D 21/0231; B65D 85/8058; B65D 2203/12

(57) ABSTRACT

A tubular container and a beverage brewing device thereof are provided. The tubular container includes a barrel-shaped tube body having one or two access openings. The one or two access openings each have a threaded structure that can be an internal thread structure or an external thread structure for engaging another device, such as another tubular container or another beverage brewing device. The tubular container further includes a blocking structure disposed at each of the access openings, and the blocking structure is used for sealing contents that are used for brewing beverages and filled in the tubular container. A thread structure of the beverage brewing device engages with the tubular container that is provided in a form of a single tubular container or a combination of a plurality of tubular containers, in which the plurality of tubular containers are combined with mutually corresponding thread structures.

### FIELD OF THE DISCLOSURE

The present disclosure relates to a container for brewing beverages, and more particularly to a tubular container that can be used alone or in combination and a beverage brewing device thereof.

### BACKGROUND OF THE DISCLOSURE

Beverages can usually be obtained through brewing, purchasing commercially available packaged beverages, and purchasing from an on-site beverage store.

When making beverages, performing a proper brewing method is difficult for ordinary people, and even if acceptable beverages are made through trial and error, the beverages often lose their original flavors.

A conventional method of brewing beverages requires a specific brewing machine and ingredient capsule packages that are adapted to the brewing machine, the ingredient capsule packages are filled with ingredients of a fixed portion by manufacturers, and a user can brew beverages by disposing the ingredient capsule packages in the specific brewing machine.

### SUMMARY OF THE DISCLOSURE

In response to the above-referenced technical inadequacies, the present disclosure provides a tubular container (operable for both a predetermined formula set by manufacturers and a formula determined by a user) and a beverage brewing device corresponding to the tubular container.

In one aspect, the present provides a tubular container, which includes a barrel-shaped tube body having one end that is provided with a first access opening, a first threaded structure disposed at the first access opening, wherein the first threaded structure is used for engaging another device, and a blocking structure disposed at the first access opening. The blocking structure is a structure capable of being punctured or dissolved, and is used for sealing contents filled in the tubular container, and the contents are used for brewing beverages.

In certain embodiments, the first thread structure is an internal thread structure or an external thread structure for engaging with a thread structure corresponding to the another device. In certain embodiments, the another device is another tubular container or a beverage brewing device.

In certain embodiments, a thread structure of the beverage brewing device engages with the tubular container that is provided in a form of a single tubular container or a combination of a plurality of tubular containers, in which the plurality of tubular containers are combined with mutually corresponding thread structures.

In certain embodiments, the first access opening is provided with the first threaded structure, and the other end of the tubular container is sealed.

In certain embodiments, the tubular container has one end that is a first access opening, and another end that is a second access opening, and the second access opening is provided with a second thread structure.

In certain embodiments, the first thread structure and the second thread structure are identical internal thread structures or identical external thread structures, or the first thread structure and the second thread structure are different internal thread structures or different external thread structures.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a beverage brewing device in one embodiment of the present disclosure;

FIG. 2 is a block diagram of a circuit system of the beverage brewing device that utilizes a tubular container in one embodiment of the present disclosure;

FIGS. 3A and 3B are each a schematic view of a structural embodiment of a tubular container in one embodiment of the present disclosure.

FIG. 4 is a schematic view showing a tubular container with an internal thread structure being butted with a tubular container with an external thread structure in one embodiment of the present disclosure;

FIG. 5 is a schematic view showing a tubular container with both internal and external threads in one embodiment of the present disclosure;

FIG. 6 is a schematic view showing a tubular container having external thread structures at both ends in one embodiment of the present disclosure;

FIG. 7 is a schematic view showing a tubular container having internal thread structures at both ends in one embodiment of the present disclosure;

FIGS. 8A to 8E are schematic views of various tubular container combinations in embodiments of the present disclosure;

FIGS. 9A to 9D show schematic views of detailed structures of the tubular containers in embodiments of the present disclosure;

FIG. 10 is a schematic view showing the tubular container of the beverage brewing device in use in one embodiment of the present disclosure;

FIG. 11 is a schematic view showing the tubular container of the beverage brewing device in use in another embodiment of the present disclosure; and

FIG. 12 is a schematic view showing the beverage brewing device used in cooperation with the tubular container to brew beverages in one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

A tubular container that can flexibly configure beverage ingredients and a beverage brewing device corresponding to the tubular container are provided in the present disclosure. The tubular container is filled with a single ingredient or a mixture of multiple ingredients, and a user can have different ingredients in cooperation with different brewing methods according to personal preferences.

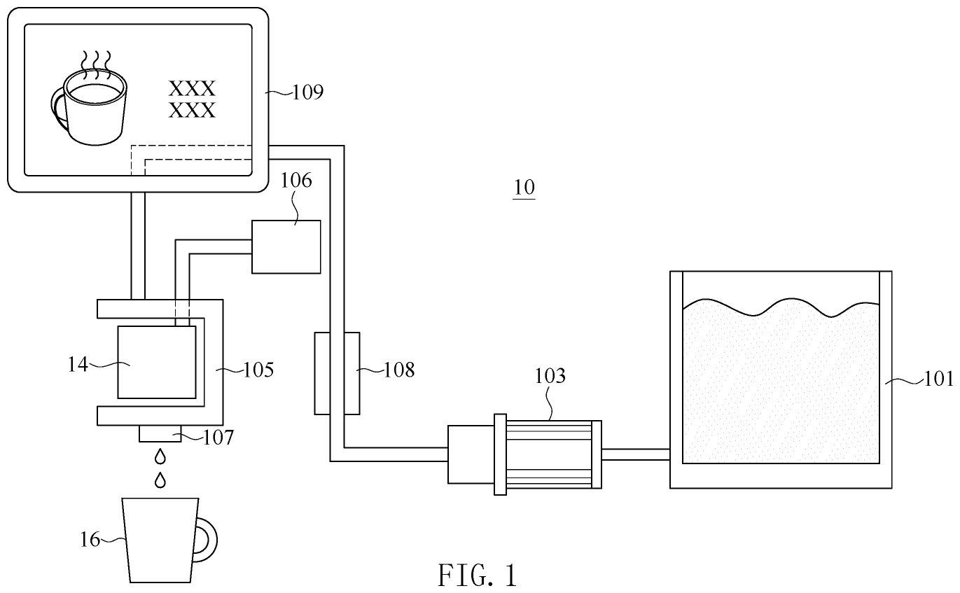

FIG. 1 is a schematic view of a beverage brewing device in one embodiment of the present disclosure. As shown in FIG. 1, the beverage brewing device 10 includes a built-in or external sink 101. Water (or fluid with certain ingredients) can be transferred to a container carrying mechanism 105 configured with the tubular containers 14 by a pump 103 through a pipeline. A temperature adjusting device 108 can be disposed on the pipeline to adjust temperature of the water, and a beverage can then be brewed from ingredients in the tubular containers 14. The beverage can be filled into a container, such as a cup 16 as shown in FIG. 1, through a beverage outlet 107.

In one of the embodiments, a display panel 109 can be disposed on the beverage brewing device, so as to present information that notify the user brewing the beverages. The display panel 109 further provides a control interface, such that the user can adjust the brewing parameters and select the brewing methods according to user preferences. After the brewing method is decided by the user, the beverage brewing device generates a command and conducts a process of brewing the beverages through a processor thereof controlling the circuit components.

In one of the embodiments, the temperature adjusting device 108 can be adopted with a thermoelectric chip, in cooperation with setting parameters. When a current is conducted to a thermoelectric material of the thermoelectric chip through an electrode, an endothermic or an exothermic effect occurs on a material interface of the thermoelectric material, thus allowing the cooling or heating of the water or a certain fluid in the pipeline to be controlled through adjusting the current and directions of the current.

In one of the embodiments, the beverage brewing device 10 can include an air adding device 106, and an air tube of the air adding device 106 is connected to the container carrying mechanism 105 and extended into the tubular container 14 to add air to contents in the tubular container 14, whereas the air is added into the tubular container 14 after the water is transferred to the tubular container 14. However, in another embodiment, the air can be added into the water before the water is transferred to the tubular container 14.

It is worth mentioning that the tubular container 14 of the container carrying mechanism 105 can be a container filled with extracts, e.g., tea extracts, fruit extracts, herb extracts, essence extracts (ingredients mixed in a predetermined ratio), concentrates, etc. Furthermore, the contents can also be tea leaves, coffee powder, juice powder, and Chinese medicine powder. For example, a formula of the extracts can be represented as one of the following: juice concentrate+sparkling water=100% juice soda, juice concentrate powder+sparkling water=100% juice soda, juice extract+sparkling water=100% juice soda, or juice extract powder+sparkling water=100% juice soda. Therefore, the juice concentrate or the juice extract is able to be reconstituted with sparkling water into 100% juice, and transforming the 100% juice into juice soda. In one embodiment, the beverage brewing device 10 can receive tubular containers 14 used alone or in combination to provide a variety of brewed beverages.

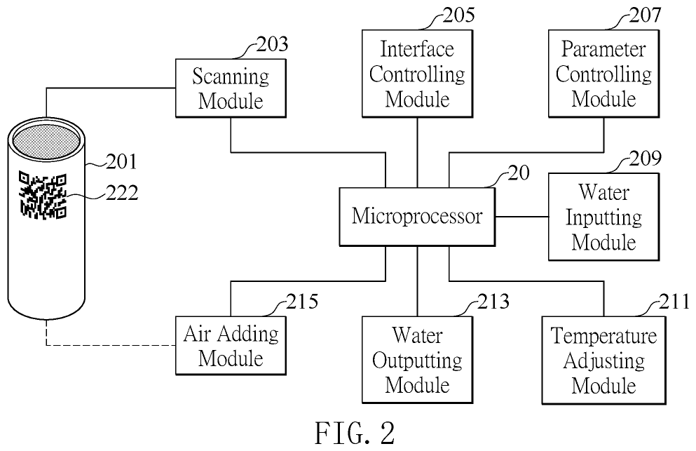

FIG. 2 is a block diagram of a circuit system of the beverage brewing device in one embodiment of the present disclosure. The circuit system includes a microprocessor 20, and a plurality of circuit components connected to the microprocessor 20. The circuit components include a tubular container 201, a scanning module 203, an interface controlling module 205, a parameter controlling module 207, a water inputting module 209, a temperature adjusting module 211, a water outputting module 213, and an air adding module 215. The microprocessor 20 is utilized to control an operation of the beverage brewing device, including processing functions and signals of the circuit components.

According to one of the embodiments, when the tubular container 201 with an identification tag 222 is configured in the beverage brewing device, the microprocessor 20 detects the presence of the tubular container 201 through related structures or electrical signals, and controls the scanning module 203 to scan the identification tag 222. The identification tag 222 can be an identification pattern or a wireless identification tag, which can be patterns such as one-dimensional bar code, two-dimensional code, or patterns that are coded in a certain manner. The two-dimensional code can be a quick response code (QR code), and the wireless identification tag can be a radio frequency identification tag (RFID tag), which is recorded with a wireless identification signal. The scanning module 203 can be a scanner that identifies patterns or RFID tags, which reads the information recorded therein.

The microprocessor 20 obtains the brewing parameters that are read from the identification tag 222 via the scanning module 203. Afterwards, in one embodiment, the beverage brewing device includes the interface controlling module 205, which informs the user of the brewing parameters and provides a function for adjustments. For example, the display panel which presents the brewing parameters can be provided. For example, the formulas of different extracts, which are provided by manufacturers providing the contents of the tubular container 201, are recorded in the identification tag 222, in a manner of encoding the brewing parameters in the identification tag 222. The microprocessor 20 can automatically brew the beverages (e.g., tea and juice) according to the brewing parameters obtained through reading the codes. The brewing parameters can include a ratio of water, a water temperature, and ingredients of additives, as well as time, pressure, temperature, amount of air added for brewing beverages.

The interface controlling module 205 provided in the present disclosure provides the user interface, e.g., touchscreen, buttons, etc., which provide the user for adjusting the brewing parameters according to personal preferences, or applying the default brewing parameters set by the manufacturers. The following brewing procedure will only continue after determining the brewing parameters.

Afterwards, the microprocessor 20 provides the obtained brewing parameters to the parameter controlling module 207, and the parameter controlling module 207 generates operating parameters that control the circuit components including the water inputting module 209, the temperature adjusting module 211, the water outputting module 213, and the air adding module 215, according to the brewing parameters.

For example, the water inputting module 209 includes the pump connected to the sink, and the water inputting module 209 controls volume and flowrate of water inputting the tank through the pipeline, according to the operating parameters generated by the parameter controlling module 207, and then the water is outputted in the tubular container 201. The water inputting module 209 can also monitor water volumes of the sink and the tank. The sink is configured with the temperature adjusting module 211 that controls cooling, heating, and temperature controlling sequence of the contents in the tubular container 201 according to the operating parameters. Moreover, some of the brewing procedures require heating up and cooling down rapidly; or conversely, heating up and cooling down slowly. During the brewing procedure, when the contents reside in the tubular container 201, the water outputting module 213 can determine time and flowrate of water outputted from the tubular container 201 according to the operating parameters, and then the processor 20 controls the air adding module 215 to determine whether or not to add air, or the amount of air to add to the beverage according to the operating parameters.

It is worth mentioning that the water in the sink, the tank, and the water being transferred can be substituted by other fluids, and the fluid can also brew the contents in the tubular container 201 through the water inputting module 209, the temperature adjusting module 211, the water outputting module 213 and the air adding module 215, and then be outputted to a specific container.

Furthermore, the content in the tubular container 201 can be an ingredient with a single component (e.g., tea leaves and coffee powder), or a mixture of multiple ingredients in a predetermined ratio. In one embodiment, the tubular container 201 can be configured as a combination of a plurality of (two or more) tubular containers filled with different contents, so as to brew proper beverages according to the brewing parameters. An appearance of the tubular container applied to the beverage brewing device described in the above embodiments is preferably a long tube wall, which has a shape of a cylinder, a square column, or a column in any shape. The tube wall is preferably made of reusable and recyclable materials, and more particularly a heat resistive material and a pressure resistive material. The tubular container formed by the tube wall and access openings at two sides thereof forms a space for filling with concentrate ingredients for brewing. The access openings at both ends of the tubular container each have a blocking structure, which can be made of water permeable materials or penetrable materials, and can be designed as a thin film that can be made of a water permeable material or a water soluble material. When the blocking structure is made of the water soluble material, the blocking structure can be dissolved upon contacting water or certain fluids (injected from the outside), so as to produce the beverage.

In another embodiment, the blocking structure can be designed as a thin film which breaks when the water pressure reaches a threshold, such that the beverage flows out. In addition, the blocking structure can be designed as a valve which opens when the water pressure reaches a threshold, such that the beverage flows out of the tubular container.

It is worth mentioning that, when the tubular container is utilized in certain beverage brewing devices, each type of the beverage brewing devices can be compatible with the tubular container; or on the contrary, each type of the beverage brewing devices can be compatible with only the tubular container for each of the types, respectively. Moreover, a design of the tubular container should be in compliance with that of the compatible beverage brewing device in length, exit diameter, material, and content weight, ingredients, and characteristics of the contents. Otherwise, the tubular container will be incompatible with the specific beverage brewing device.

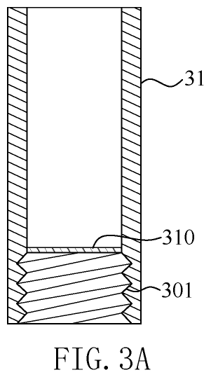

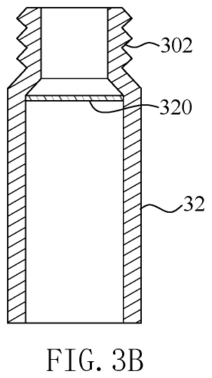

FIGS. 3A and 3B are each a schematic view of a structural embodiment of a tubular container in one embodiment of the present disclosure.

FIG. 3A shows a tubular container 31 having one end with an opening and an internal thread structure 301 therein, a blocking structure 310 capable of being punctured or dissolved is provided in the tubular container 31 to seal contents filled in the tubular container, and the contents are used for brewing beverages. In this example, one end of the tubular container 31 is a first access opening, and the other end is sealed.

In particular, the tubular container 31 can be combined with a container carrying mechanism in the beverage brewing device through the inner thread structure 301, and can also be combined with other tubular containers 31 through the inner thread structure 301. The blocking structure 310 can preferably be made of a material that is susceptible to air pressure, hydraulic pressure, or physical puncture, such as aluminum foil, film, plastic, paper, and the like, and the tubular container 31 contains edible or drinkable concentrated extracts or powders, or liquids liquid.

Correspondingly, FIG. 3B shows a tubular container 32 having one end with an opening, an external thread structure 302, and a blocking structure 320, and the contents for brewing beverages are likewise filled in the tubular container 32. In this example, one end of the tubular container 32 is the first access opening, and the other end is also designed to be sealed.

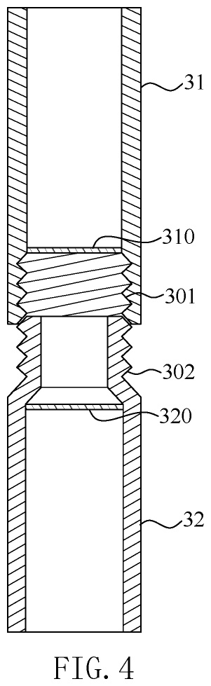

FIGS. 3A and 3B respectively show the tubular container 31 with the internal thread structure 301 and the tubular container 32 with the external thread structure 302, and the tubular containers 31 and 32 can be butted with each other, as shown in FIG. 4, the tubular container 31 is shown in rotational engagement with the tubular container 32 by means of a threaded structure.

According to the above embodiments, the tubular container can be loaded into the container carrying mechanism of the beverage brewing device individually or in combination, therefore, contents of the different tubular containers can be mixed when brewing beverages to provide a variety of brewing combinations.

In the above embodiment, the tubular container has a barrel-shaped tube body, and a cross-sectional area of which is not limited to any shape. In a design related to the tube lengths of the above-mentioned tubular containers, only a longest length for each of the tubular containers is defined; in other words, tubular containers with lengths shorter than the longest length will be compatible with the beverage brewing device. In addition, the design can configure two or more tubular containers in one of the beverage brewing devices through stacking, as long as the tubular containers do not exceed the longest length. That is to say, the tubular container can be a combination of a plurality of tubular containers filled with different contents.

It should be noted that the tube wall of the tubular containers can be made of transparent, translucent, or certain materials, or the identification tag may be marked on the outside, such that, when the tubular containers are to be used on the beverage brewing device for brewing beverages, a part of each of the tubular containers is exposed, such that the user can see the brewing process from the outside or that the contents of the tubular container can be known directly from the identification tag on the tubular container. Therefore, the tubular containers can be utilized in the following implementations.

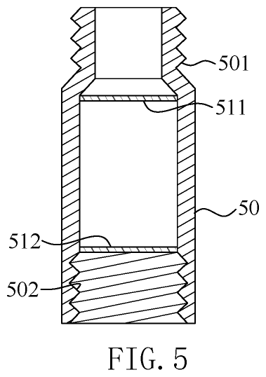

Furthermore, the tubular container provided in the present disclosure has more structural changes. Reference is made to FIG. 5, which is a schematic view showing a tubular container with both internal and external threads in one embodiment of the present disclosure.

As shown in FIG. 5, the tubular container 50 has access openings at both ends, including a first access opening and a second access opening, which are respectively provided with threaded structures that can be engaged with another device. A length and outlet diameter of the barrel-shaped tube body of the tubular container are compatible with the another device to be engaged. The another device can be another tubular container or a beverage brewing device, in which an internal thread structure or an external thread structure is provided for engaging the tubular container. In FIG. 5, an external thread structure 501 and an internal thread structure 502 are shown in this example. A first blocking structure 511 and a second blocking structure 512 for sealing contents are provided at the first access opening and the second access opening, respectively, and the first blocking structure 511 and the second blocking structure 512 can similarly be made of a material that is susceptible to air pressure, hydraulic pressure, or physical puncture, such as aluminum foil, film, plastic, paper, and the like, and the tubular container 50 contains edible or drinkable concentrated extracts or powders, or liquids liquid.

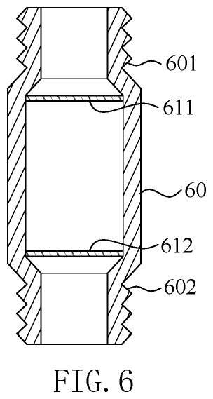

FIG. 6 is a schematic view showing a tubular container having external thread structures at both ends in one embodiment of the present disclosure. As shown in FIG. 6, two access openings at both ends of a tubular container 60 are provided with a first external thread structure 601 and a second external thread structure 602, respectively, and are also provided with a first blocking structure 611 and a second blocking structure 612, respectively.

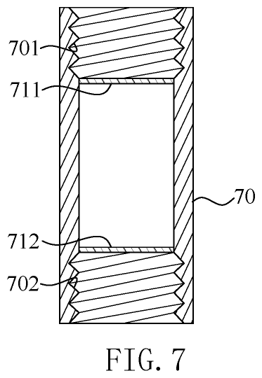

FIG. 7 is a schematic view showing the tubular container 70 having internal thread structures at both ends in yet another embodiment of the present disclosure. As shown in FIG. 7, the internal thread structures include a first external thread structure 701 and a second external thread structure 702, and the two access openings are similarly provided with a first blocking structure 711 and a second blocking structure 712, respectively.

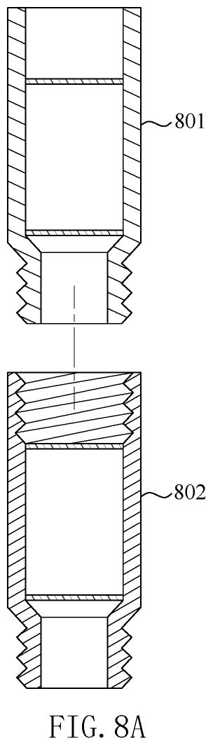

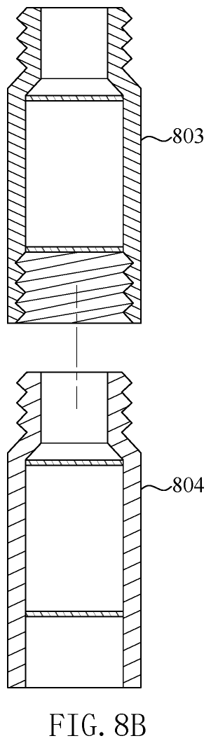

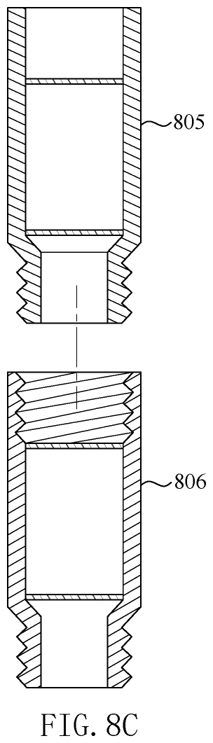

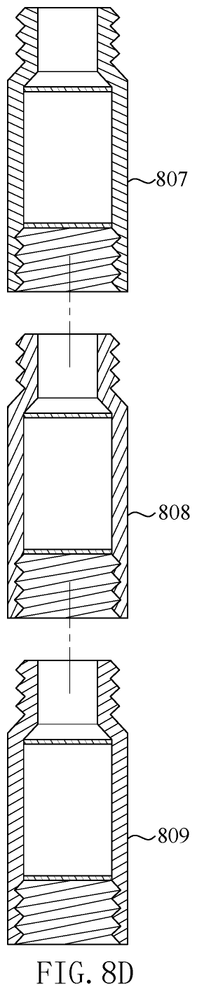

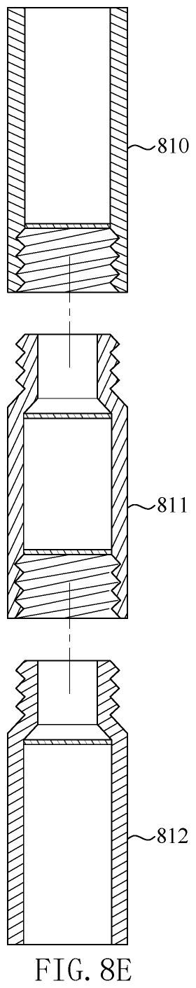

FIGS. 8A to 8E are schematic views of various tubular container combinations in embodiments of the present disclosure. In FIGS. 8A to 8E, each tubular container may have one or two openings, that is, one or two thread structures are provided for the one or two openings, respectively. Taking the tubular container having two openings as an example, identical internal thread structures or identical external thread structures can be utilized, or different thread structures can be utilized.

FIG. 8A shows a tubular container 801 having an external thread structure at one end, the external thread structure engages an internal thread structure that is located on one end of the tubular container 802, and the other end of the tubular container 802 in this example has an external thread structure.

Moreover, two ends of a tubular container 803 shown in FIG. 8B are respectively provided with an external thread structure and an internal thread structure, and the internal thread structure is used to engage an external thread structure at one end of a tubular container 804.

FIG. 8C shows that a tubular container 805 engages an inner thread structure of one end of another tubular container 806 through an external thread structure at one end of the tubular container 805, and the other end of the tubular container 806 is provided with another external thread structure.

FIG. 8D shows an embodiment in which three tubular containers 807, 808 and 809 are joined to each other with internal and external thread structures, in which the tubular container can engage the external thread structure of another tubular container with the internal thread structure thereof. After the three tubular containers 807, 808 and 809 are joined together, two ends of the whole still have access openings for engaging other objects. For example, in a container carrying mechanism of an applicable beverage brewing device, a plurality of tubular containers having compatible lengths can be joined by a thread structure in the container carrying mechanism. During a brewing process, the beverage brewing device can break through the barrier structure by water pressure or air pressure, such that contents in the three tubular containers 807, 808 and 809 can be fully mixed during the brewing process.

FIG. 8E shows three tubular containers 810, 811 and 812, which are also joined to each other by internal and external thread structures, and two ends of the whole are sealed, which are also applicable to a beverage brewing device that is compatible with lengths of the tubular containers 810, 811 and 812.

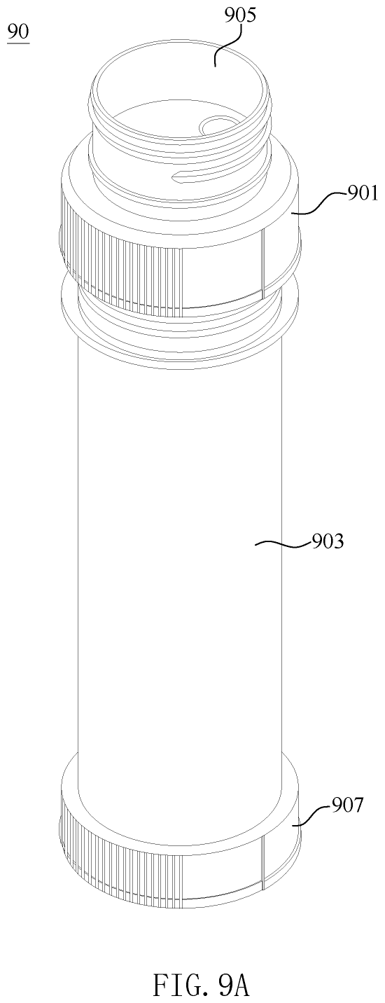

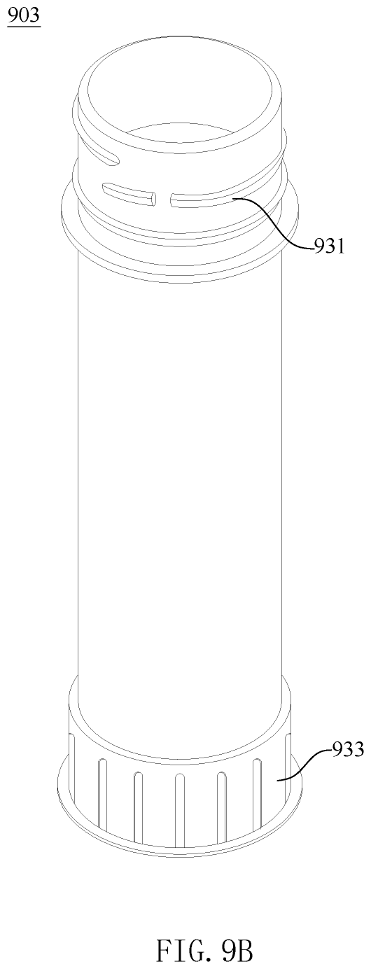

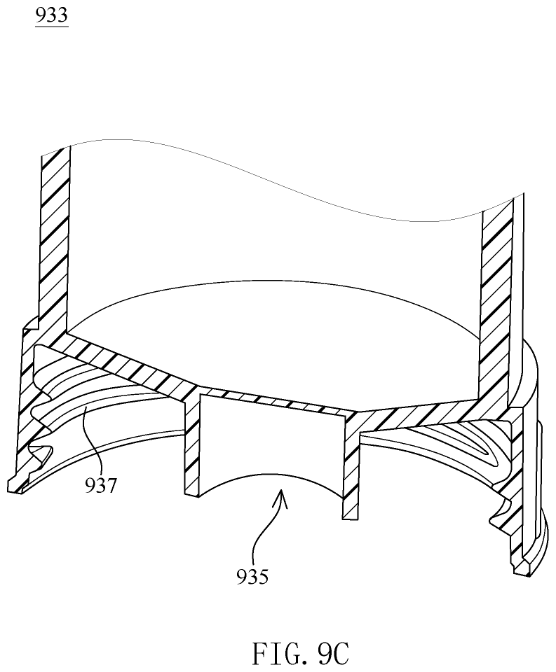

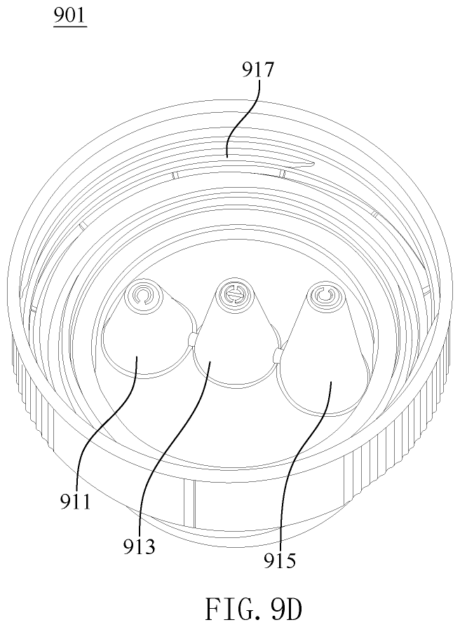

FIGS. 9A to 9D show schematic views of detailed structures of the tubular containers in embodiments of the present disclosure.

The above embodiments show that the tubular container provided by the presence disclosure is mainly connected to an external device (such as a beverage brewing device or another tubular container) through the inner thread structure and the external thread structure of the access openings. As shown in FIG. 9A, a barrel-shaped tube body of a tubular container in one embodiment includes a separable outlet portion 901 and a container portion 903 for containing fluid. The container portion 903 is used for filling contents for brewing beverage, and the outlet portion 901 is an outlet for outputting the brewed beverage. The outlet portion 901 and the container portion 903 can be engaged with each other in a threaded or sleeved manner, and the present disclosure is not limited thereto. Preferably, the embodiment shown in FIG. 9A shows that the outlet portion 901 and the container portion 903 are connected by thread structures, and the fluid can be injected into the container portion 903 of the tubular container through a fluid inlet 907 at one end of the container portion 903, and can be mixed with the contents for brewing beverages in the container portion 903. The barrier structure of the outlet 901 can be broken by hydraulic pressure or air pressure, such that a mixture of fluid (such as water or the like) and the contents can flow out for brewing the beverages.

Furthermore, since the tubular container is expandable, the tubular container provided in the present disclosure can be connected to another tubular container through a link structure in a threaded or sleeved manner. For example, a container portion of another tubular container can also be sleeved through the above-mentioned outlet portion 901, or an outlet portion of another tubular container can be connected with the container portion 903.

FIG. 9B further shows an example of the container portion 903 in the above-mentioned tubular container. An upper end of the container portion 903 shown in FIG. 9B has a first interface portion 931, which can be engaged with the outlet portion 901 of the above embodiment in a threaded or sleeved manner. A lower end of the container portion 903 in FIG. 9B has a second interface portion 933 that serves as a fluid inlet.

FIG. 9C shows a structural example of the above-mentioned second interface portion 933, in which a connection structure 937 (such as a thread) and a fluid injection port 935 are provided. The container portion 903 is connected to the beverage brewing device through the connection structure 937 in the second interface portion 933, such that the beverage brewing device injects fluid into the container portion 903 through the fluid injection port 935 to mix with the contents filled in the container portion 903.

In addition, since the tubular container is expandable, the above-mentioned container portion 903 can be connected to other tubular containers through the connection structure 937 in the second interface portion 933, for example, the container portion 903 can be connected to the outlet portion 901 of another tubular container according to the embodiment shown in FIG. 9A.

FIG. 9D further shows a structural example inside the outlet portion 901 of the tubular container. For example, a connection structure 917 for connecting to other devices (such as a beverage brewing device or another tubular container) is provided. Although the connection structure 917 in this example is shown with threads, but the present disclosure does not limit the connection structure 917 can be connected in a threaded manner only. One or more blocking structures 911, 913, 915 are set in the outlet portion 901. According to the embodiment, the blocking structures 911, 913, 915 are tapered structures, and a tip of each of the tapered structures is a fluid outflow portion. The blocking structures 911, 913, 915 can be made of film, thin plastic, aluminum foil, paper, and after being broken by hydraulic pressure or air pressure, the mixed fluid or beverages can be output.

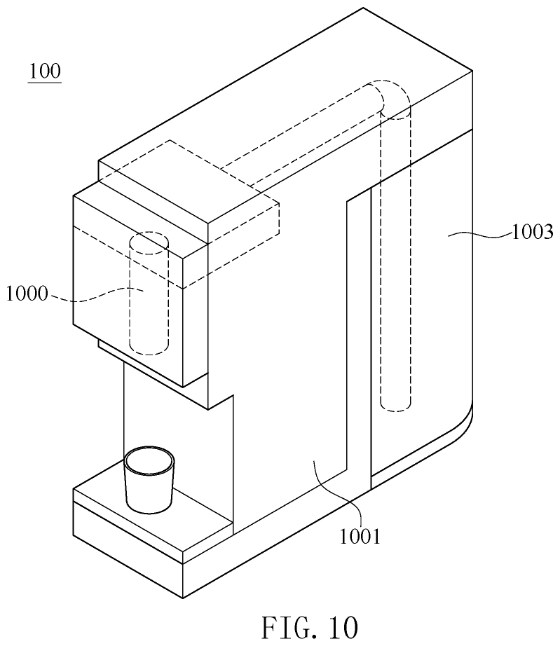

Reference is made to FIG. 10, which is a schematic view showing the tubular container of the beverage brewing device in use in one embodiment of the present disclosure. As shown in FIG. 8, a beverage brewing device 100 is provided and has a unique design of a beverage outlet, which is presented only for the purposes of illustration and description and is not intended to be exhaustive or to limit the disclosure, and the basic concept of the beverage brewing device can be understood and realized by a person having ordinary skill in the art, the beverage brewing device 100 merely utilizes the above-mentioned tubular container 1000. The beverage brewing device 100 in the embodiment includes one of the tubular containers 1000, and in practice, the beverage brewing device 100 can be different types of beverage brewing devices respectively utilizing one or more than one of the tubular containers 1000. The beverage brewing device 100 includes a main body 1001 and a water supplying device 1003 disposed on a side. When operating, water from the water supplying device 1003 can be guided to a heater (or a cooler) by the pump, and then flow into the tubular container 1000 through related pipelines, such that the contents therein can be brewed and made into beverages after being left for a period of time, or put under a pressure.

Further, according to the above embodiments, the container carrying mechanism in the beverage brewing device 100 can be equipped with a tubular container that has a compatible length, and the tubular container can be a single one or a combination of multiple tubular containers according to brewing requirements.

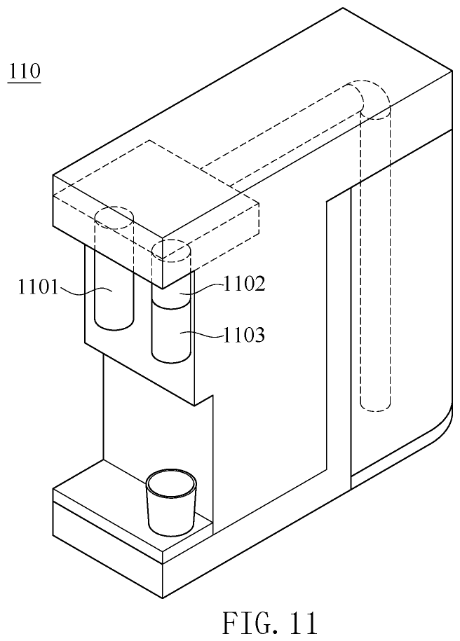

Reference is made to FIG. 11, which is a schematic view showing the tubular container of the beverage brewing device in use in still another embodiment of the present disclosure. As shown in FIG. 11, the beverage brewing device is compatible for two tubular containers, but the lengths of the two tubular containers can be different. For example, one of the two tubular containers can be a first tubular container 1101 and the other one of the two tubular containers can be a combination of a second tubular container 1102 and a third tubular container 1103. The second tubular container 1102 and the third tubular container 1103 are still fit for (the carrying structure of) the container carrying mechanism in the beverage brewing device 110 after stacking upon each other.

It is worth mentioning that, the second tubular container 1102 and the third tubular container 1103 are tubular containers with openings on both ends, which are sealed by the above-mentioned blocking structure, and are filled with ingredients for brewing certain beverages. When water is injected in one side of the combination of the second tubular container 1102 and the third tubular container 1103 that are tightly engaged with each other, the water can flow through the second tubular container 1102 and the third tubular container 1103, such that different ingredients in the second tubular container 1102 and the third tubular container 1103 can be brewed together, and then eventually be mixed with the beverage from the first tubular container 1101, thereby automatically obtaining the beverages with certain flavors.

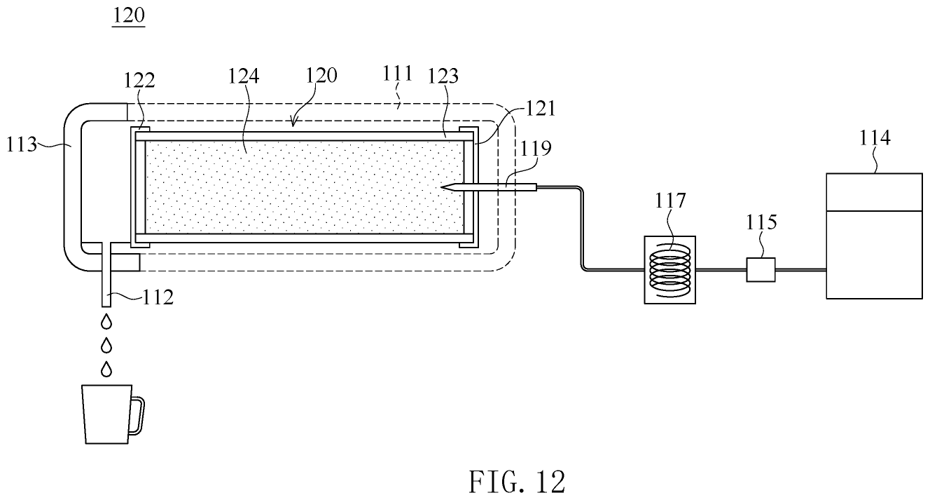

Reference is made to FIG. 12, which is a schematic view showing the beverage brewing device used in cooperation with the tubular container to brew beverages in one embodiment of the present disclosure. As shown in FIG. 12, a brewing system 130 of the beverage brewing device is provided, and the brewing system 130 includes structures, circuits, and controlling software, which are presented in figures, but the figures can be understood and realized by a person having ordinary skill in the art.

In the brewing system 130, a tubular container 120 (including a tube wall 123 and concentrate ingredients 124) can be filled, the tubular container 120 can be configured on a container carrying mechanism 111 of the beverage brewing device. In addition to the manner of configuring the tubular container 120 to the beverage brewing device vertically, the tubular container 120 can also be configured on the container carrying mechanism 111 of the beverage brewing device horizontally. The tubular container 120 can be properly connected to components in the brewing system 130 via the container carrying mechanism 111 such that the tubular container 120 is in an accommodating space isolated from the air and prevented from being affected by the temperature on the outside.

In one embodiment, one of the sides of the tubular container 120 (e.g., the blocking structure 121) is configured toward the inside of the brewing system 130 and configured on the container carrying mechanism 111, and then sealed and fixed with a cover 113. The schematic view shows that the tubular container 120 can be placed horizontally on the container carrying mechanism 111 of the brewing system 130, and a penetrating structure 119 penetrates the blocking structure 121, so as to inject water or certain fluids to brew the concentrate solutions and the concentrate powders in the tubular container 120. Afterwards, the blocking structure 122 outputs the beverage.

The brewing system 130 includes a water supplying device 114, mainly for accommodating water, the water is pumped by a pump 115 to flow to a heater 117, which outputs the water with controlled temperature, and then is injected to the tubular container 120 through the penetrating structure 119 to brew the concentrate ingredients 124. Afterwards, the beverage can be outputted through another blocking structure 122 through a design of control parameters such as time, flowrate, temperature, etc., and then flow to a cup via a specific flow guiding structure 112.

In conclusion, in the tubular container and the beverage brewing device provided by the present disclosure, the tubular container is compatible for the beverage brewing device, and can be filled with a single ingredient or a mixture of multiple ingredients mixed in a predetermined ratio. The tubular container can be a single tubular container or a combination of a plurality of different tubular containers filled with different contents respectively, so as to produce more diversified beverages and more flexible combinations of the ingredients for brewing beverages.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. A tubular container, comprising:
a barrel-shaped tube body having one end that is provided with a first access opening;
a first threaded structure disposed at the first access opening, wherein the first threaded structure is used for engaging another device; and
a blocking structure disposed at the first access opening, wherein the blocking structure is used for sealing contents filled in the tubular container, and the contents are used for brewing beverages;
wherein the tubular container further comprises an identification tag configured to record brewing parameters;
wherein a beverage brewing device comprises a scanning module and a microprocessor, the microprocessor is configured to obtain the brewing parameters that are read from the identification tag via the scanning module, and automatically brew the beverages according to the brewing parameters obtained through reading the identification tag.

2. The tubular container according to claim 1, wherein the first thread structure is an internal thread structure or an external thread structure for engaging with a thread structure corresponding to the another device, and the another device is another tubular container or the beverage brewing device.

3. The tubular container according to claim 2, wherein the first thread structure corresponds to a thread structure of a container carrying mechanism of the beverage brewing device.

4. The tubular container according to claim 3, wherein a thread structure of the container carrying mechanism engages with the tubular container that is provided in a form of a single tubular container or a combination of a plurality of tubular containers, and the plurality of tubular containers are combined with mutually corresponding thread structures.

5. The tubular container according to claim 2, wherein the first access opening is provided with the first threaded structure, and the tubular container has another end that is sealed.

6. The tubular container according to claim 2, wherein the first access opening is provided with the first threaded structure, the tubular container has another end that is provided with a second access opening, and the second access opening is provided with a second thread structure.

7. The tubular container according to claim 6, wherein the first thread structure and the second thread structure have identical internal thread structures or identical external thread structures.

8. The tubular container according to claim 6, wherein the first thread structure and the second thread structure have different internal thread structures or different external thread structures.

9. The tubular container according to claim 1, wherein the barrel-shaped tube body includes a separable outlet portion and a container portion, and the container portion is used for filling the contents for brewing the beverages.

10. The tubular container according to claim 9, wherein the outlet portion is engaged with the container portion by a threaded structure.

11. The tubular container according to claim 9, wherein the outlet portion is provided with one or more blocking structures that are air pressure-breakable or hydraulic pressure-breakable.

12. The tubular container according to claim 11, wherein the one or more blocking structures of the outlet portion are conical structures, and a tip portion of each of the conical structures is a fluid outflow portion.

13. The tubular container according to claim 1, wherein the blocking structure is a structure capable of being punctured or dissolved.

14. A beverage brewing device, configured to engage the tubular container as claimed in claim 1 by a thread structure of a container carrying mechanism provided in the beverage brewing device.
